(19) United States
(12) Patent Application Publication
(10) Pub. No.: US 2011/0008695 A1
(43) Pub. Date: Jan. 13, 2011

(54) FUEL CELL SYSTEM AND METHOD OF CONTROLLING A FUEL CELL SYSTEM

(75) Inventors: Go Tejima, Toyota-shi (JP); Toshiyuki Kondo, Chiryu-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi (JP)

(21) Appl. No.: 12/918,005

(22) PCT Filed: Feb. 10, 2009
(86) PCT No.: PCT/JP2009/000536

§ 371 Date: Aug. 25, 2010

(30) Foreign Application Priority Data
Feb. 19, 2008 (JP) 2008-037268

(51) Int. Cl. H01M 8/04

(52) U.S. Cl. 429/429

(57) ABSTRACT

If subsequent to discontinuing generation by the fuel cell stack it is predicted that evolved water formed by electrochemical reaction of a fuel gas and an oxidant gas during generation may freeze in the membrane-electrode assembly provided to the fuel cell stack, low-level generation (temperature gradient formation control) is carried out until the temperature of the membrane-electrode assembly is relatively higher than the temperature of the separators. This temperature gradient formation control is carried out only for the time period necessary to produce a temperature gradient between the membrane-electrode assembly and the separators, and is quickly discontinued once a temperature gradient is created between the membrane-electrode assembly and the separators. Thus, in a fuel cell system equipped with a fuel cell, reduced energy efficiency of the fuel cell system may be avoided, and low temperature startup may be improved.

### TECHNICAL FIELD

The present invention relates to a fuel cell system and to a method of controlling a fuel cell system.

### BACKGROUND ART

Fuel cells, which generate electricity through an electrochemical reaction between a fuel gas (e.g. hydrogen) and an oxidant gas (e.g. oxygen), are noted as energy sources. A fuel cell is composed of a membrane-electrode assembly having an anode and a cathode respectively joined to either side of an electrolyte membrane with proton conductivity, and sandwiched between separators. At the cathode of the membrane-electrode assembly, water (evolved water) is evolved as a result of the cathode reaction during electricity generation.

In a fuel cell system furnished with such a fuel cell, if the temperature of the fuel cell falls below the freezing point after generation by the fuel cell is interrupted, evolved water present in the membrane-electrode assembly freezes. If the fuel cell system is started up under these conditions, the supply of fuel gas to the anode of the membrane-electrode assembly and the supply of oxidant gas to the cathode are hampered by the frozen evolved water, and the generating capability of the fuel cell drops.

Accordingly, in the field of fuel cell systems, a number of different techniques for preventing evolved water from freezing inside the fuel cell after generation is discontinued have been proposed to date.

Patent Document 1: JP-A 2004-22198

Patent Document 2: JP-A 2006-107901

Patent Document 3: JP-A 2004-327101

Patent Document 4: JP-A 2005-322527

### DISCLOSURE OF THE INVENTION

### Problem the Invention Attempts to Solve

However, the prior art techniques disclosed in the preceding Patent Documents involve operating the fuel cell to expel evolved water remaining inside the fuel cell to the outside, or operating the fuel cell to maintain the temperature above freezing; and because these operations consume energy, the energy efficiency of the fuel cell system is reduced.

An advantage of some aspects of the invention is to avoid reduced energy efficiency of the fuel cell system and to improve low-temperature startup in a fuel cell furnished with a fuel cell.

### Means for Solving the Problem

The present invention is addressed to attaining the above objects at least in part according to the following aspects of the invention.

### First Aspect

A fuel cell system comprising:
a fuel cell including a membrane-electrode assembly having an anode and a cathode respectively joined to either side of an electrolyte membrane and being sandwiched by separators;
a fuel gas supply portion which supplies a fuel gas to the anode;
an oxidant gas supply portion which supplies an oxidant gas to the cathode;
a cooling medium circulating portion which circulates a cooling medium for cooling the fuel cell through cooling medium channel formed in the separator; and
a controller, wherein
subsequent to discontinuing generation by the fuel cell, the controller,
   if predicted that evolved water formed by electrochemical reaction of the fuel gas and the oxidant gas during generation may freeze in the membrane-electrode assembly, starts up at least one of the fuel gas supply portion, the oxidant gas supply portion, and the cooling medium circulating portion to carry out temperature gradient formation control which creates a temperature gradient between the membrane-electrode assembly and the separator such that a temperature of the membrane-electrode assembly is relatively higher than a temperature of the separator; and terminates the temperature gradient formation control once the temperature gradient is created between the membrane-electrode assembly and the separator.

According to the fuel cell system of the first aspect, if predicted subsequent to discontinuing generation by the fuel cell that evolved water evolved by the electrochemical reaction of the fuel gas and the oxidant gas during generation may freeze in the membrane-electrode assembly, at least one of the fuel gas supply section, the oxidant gas supply section, and the cooling medium circulating section is operated; and temperature gradient formation control is carried out to create a temperature gradient between the membrane-electrode assembly and the separators such that the temperature of the membrane-electrode assembly is relatively higher than the temperature of the separators. Doing so creates a vapor pressure gradient between the membrane-electrode assembly and the separator, giving rise to driving force that transports evolved water present in the membrane-electrode assembly from the membrane-electrode assembly side, where the vapor pressure is higher, to the separator side, where the vapor pressure is lower. Consequently, evolved water present in the membrane-electrode assembly becomes transported towards the separator side so that freezing of evolved water in the membrane-electrode assembly in a low-temperature environment below freezing may be avoided. Low-temperature startup of the fuel cell system may be improved as a result.

Temperature gradient formation control is carried out only for the time period necessary to produce that the desired temperature gradient is between the membrane-electrode assembly and the separators, and is quickly discontinued once this temperature gradient is created. Thus, as compared with the prior art discussed earlier, namely, operating the fuel cell to expel evolved water remaining inside the fuel cell to the outside or operating the fuel cell to maintain the temperature above freezing, reduced energy efficiency of the fuel cell system may be avoided.

Various different methods may be employed to predict whether freezing may occur in the membrane-electrode assembly. For example, in one possible arrangement, the fuel cell is provided with a temperature sensor, the temperature of the fuel cell is sensed in an appropriate manner by this temperature sensor, and the determination as to whether evolved water may freeze in the membrane-electrode assembly is made on the basis of sensed temperature or the rate of change in temperature. The determination as to whether evolved water may freeze in the membrane-electrode assembly may be made on the basis of at least one of the outside environmental temperature environment of the fuel cell, the rate of change in environmental temperature, the temperature of the cooling medium, and the rate of change in temperature of the cooling medium.

### Second Aspect

The fuel cell system in accordance with claim 1 wherein
the controller accomplishes the temperature gradient formation control by starting up the fuel gas supply portion and the oxidant gas supply portion, and generating electricity with the fuel cell to bring the temperature of the membrane-electrode assembly above the temperature of the separator.
According to the fuel cell system of the second aspect, the temperature of the membrane-electrode assembly may be increased to a level higher than the temperature of the separators. During temperature gradient formation control it is necessary merely to create a temperature gradient between the membrane-electrode assembly and the separators, and thus lower level generation than during steady generation is sufficient.

### Third Aspect

The fuel cell system in accordance with claim 1 wherein
the controller accomplishes the temperature gradient formation control by starting up the cooling medium circulating portion and circulating the cooling medium through the separator to bring the temperature of the separator below the temperature of the membrane-electrode assembly.
According to the fuel cell system of the third aspect, the temperature of the membrane-electrode assembly may be increased to a level higher than the temperature of the separators.

### Fourth Aspect The fuel cell system in accordance with claim 1 wherein

the anode and the cathode contain a catalyst which facilitates reaction of the fuel gas and the oxidant gas,
the fuel cell system further includes a mixed gas supply portion which supplies a mixed gas of the fuel gas and the oxidant gas to at least one of the anode and the cathode, and
the controller accomplishes the temperature gradient formation control by starting up the mixed gas supply portion and combusting the mixed gas on the catalyst to bring the temperature of the membrane-electrode assembly above the temperature of the separator.
According to the fuel cell system of the fourth aspect, the temperature of the membrane-electrode assembly may be increased to a level higher than the temperature of the separators.
The present invention may also be embodied through suitable combinations of certain of the various different features of described above. In addition to embodiment as a fuel cell system as discussed above, the present invention may be embodied as a method of controlling a fuel cell. Other possible embodiments of the invention include a computer program for realization thereof; a recording medium having the computer program recorded thereon; or a data signal containing the program and carried on a carrier wave. The various supplemental elements mentioned previous may be implemented in these respective embodiments as well.
Where the present invention is embodied as a computer program or a recording medium having the program recorded thereon, it may constitute the entire program for controlling operations of the fuel cell system, or only that portion used to carry out the functions of the present invention. Various computer-readable media may be employed as the recording medium, such as a flexible disk, CD-ROM, DVD-ROM, magnetooptical disk, IC card, ROM cartridge, punch card, printed matter imprinted with symbols such as a bar code, computer internal memory devices (memory such as RAM and ROM), and external memory devices.

### BRIEF DESCRIPTION OF THE DRAWINGS

FIG. 1 Illustration depicting the general features of a fuel cell system 1000 according to a first embodiment of the invention.

FIG. 2 Flowchart showing the flow of an operation control process subsequent to discontinuing generation by a fuel cell stack 100 according to the first embodiment.

FIG. 3 Illustration depicting working effects of the operation control process subsequent to discontinuing generation.

FIG. 4 Flowchart showing the flow of an operation control process subsequent to discontinuing generation in a fuel cell stack 100 according to a second embodiment.

FIG. 5 Illustration depicting the general features of a fuel cell system 1000A according to a third embodiment of the invention.

FIG. 6 Flowchart showing the flow of an operation control process subsequent to discontinuing generation in a fuel cell stack 100 according to the third embodiment.

### BEST MODE FOR CARRYING OUT THE INVENTION

The modes of working the present invention are described below based on certain preferred embodiments.

### A. FIRST EMBODIMENT

### A1. Features of Fuel Cell System:

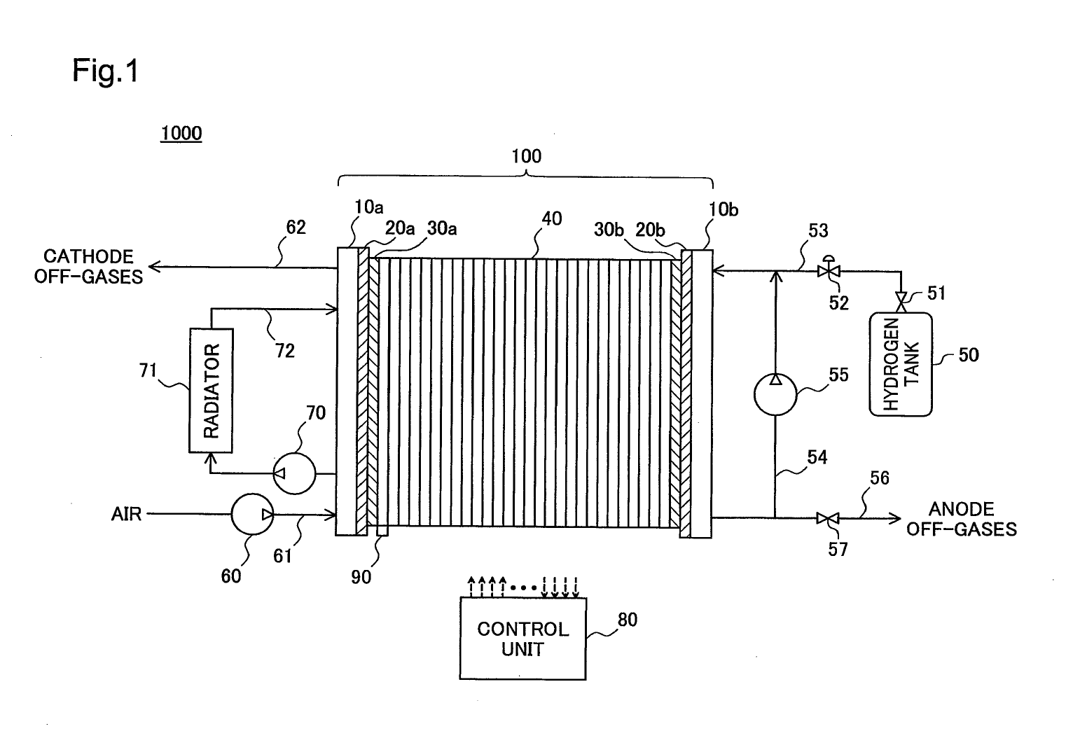

FIG. 1 is an illustration depicting the general features of a fuel cell system 1000 according to a first embodiment of the invention.

The fuel cell stack 100 has a stacked structure having a plurality of unit cells 40 which generate electricity through an electrochemical reaction of hydrogen and oxygen. Each unit cell 40 is generally composed of a membrane-electrode assembly that has an anode and a cathode respectively joined to either side of an electrolyte membrane with proton conductivity, and that is sandwiched by separators. The anode and the cathode each includes a catalyst layer that is joined to one of the surfaces of the electrolyte membrane, and a gas diffusion layer that is joined to the surface of the catalyst layer. In the present embodiment, the electrolyte membrane is a solid polymer membrane of NAFION™ or the like. However, other electrolyte membranes, such as solid oxides, may be used as the electrolyte membrane. In each of the separators there are formed channels for supplying hydrogen to the anode as the fuel gas, channels for supplying air to the cathode as the as oxidant gas, and channels for a cooling medium (such as water or ethylene glycol). The number of stacked unit cells 40 may be selected freely according to the output required of the fuel cell stack 100.

The fuel cell stack 100 includes, in order from one end, an end plate 10a, an insulating plate 20a, a collector plate 30a, a plurality of unit cells 40, a collector plate 30b, an insulating plate 20b, and an end plate 10b. These are provided with supply ports and discharge ports for circulating hydrogen, air, and coolant within the fuel cell stack 100. Within the fuel cell stack 100 there are also provided supply manifolds (a hydrogen supply manifold, an air supply manifold, and a cooling medium supply manifold) for distributed supply of hydrogen, air, and cooling medium to the unit cells 40; and discharge manifolds (an anode off-gas discharge manifold, a cathode off-gas discharge manifold, and a cooling medium discharge manifold) for collecting the cooling medium and the anode off-gases and cathode off-gases discharged by the anodes and cathodes of the individual unit cells 40, and discharging these to the outside of the fuel cell stack 100.

The fuel cell stack 100 is also furnished with a temperature sensor 90 for sensing the temperature of the unit cells 40. As illustrated, in the present embodiment, the temperature sensor 90 is disposed on a unit cell 40 that is situated at one end in the direction of stacking of the unit cells 40, which is susceptible to a drop in temperature due to heat radiation.

The end plates 10a, 10b are made of metal such as steel in order to ensure rigidity. The insulating plates 20a, 20b are made of insulating members of rubber, resin, or the like. The collector plates 30a, 30b are made of gas-impermeable, conductive members of dense carbon, copper sheets, or the like. The collector plates 30a, 30b are respectively provided with output terminals, not shown, and are adapted to output electricity generated by the fuel cell stack 100.

While not shown in the drawings, the fuel cell stack 100 is fastened together by fastening members adapted to exert prescribed fastening load in the stacking direction of the stack structure, in order to prevent a drop in cell performance caused by increased contact resistance at any point in the stack structure and to prevent leakage of gases.

Via a line 53, the anodes of the fuel cell stack 100 are supplied with hydrogen fuel gas from a hydrogen tank 50 that stores high-pressure hydrogen. As an alternative to the hydrogen tank 50, a hydrogen-rich gas may be generated through a reforming reaction of a feedstock such as an alcohol, hydrocarbon, or aldehyde, and supplied to the anodes.

The high-pressure hydrogen stored in the hydrogen tank 50, after the pressure and feed rate are adjusted by a shutoff valve 51 provided at the outlet of the hydrogen tank 50 and by a regulator 52, is supplied to the anodes of the unit cells 40 via the hydrogen supply manifold. The anode off gases discharged by the unit cells 40 may be discharged from the fuel cell stack 100 via a discharge line 56 connected to the anode off-gas discharge manifold. When anode off gases are discharged from the fuel cell stack 100, the hydrogen contained in the anode off gases may be treated in a diluting unit or the like.

A recirculation line 54 for recirculating the anode off-gases to the line 53 is connected to the line 53 and the discharge line 56. An exhaust valve 57 is disposed downstream from the connection of the discharge line 56 with the recirculation line 54. A pump 55 is situated on the recirculation line 54. By controlling actuation of the pump 55 and the exhaust valve 57 it is possible to appropriately switch between venting the anode off-gases to the outside and recirculating them to the line 53. By recirculating anode off-gases to the line 53, unconsumed hydrogen contained in the anode off-gases can be efficiently utilized.

Via a line 61, the cathodes of the fuel cell stack 100 are supplied with compressed air compressed by a compressor 60, as the oxygen-containing oxidant gas. This compressed air is then supplied to the cathodes of the individual unit cells 40 via the air supply manifold that is connected to the line 61. The cathode off gases discharged by the cathodes of the unit cells 40 are discharged from the fuel cell stack 100 via a discharge line 62 connected to the cathode off-gas discharge manifold. Evolved water formed by the electrochemical reaction of hydrogen and oxygen on the cathodes of the fuel cell stack 100 is expelled together with the cathode off-gases from the discharge line 62.

Because the fuel cell stack 100 emits heat due to the electrochemical reaction discussed above, the fuel cell stack 100 is also supplied with a cooling medium to cool down the fuel cell stack 100. This cooling medium is circulated through a line 72 by a pump 70, cooled by a radiator 71, and supplied to the fuel cell stack 100.

While not illustrated in the drawings, the fuel cell stack 100 is housed within a heat insulating case in order to prevent freezing of evolved water inside the fuel cell stack 100 in a low-temperature environment at or below freezing.

Operation of the fuel cell system 1000 is controlled by a control unit 80. The control unit is designed as a microcomputer having an internal CPU, RAM, ROM, a timer and other components, and is adapted to control operation of the system, such as actuation of the various different valves and pumps for example, according to a program stored in the ROM. In the fuel cell system 1000 of the present embodiment, the control unit 80 carries out an operation control process, discussed below, after generation by the fuel cell stack 100 is discontinued.

### A2. Operation Control Process After Discontinuing Generation:

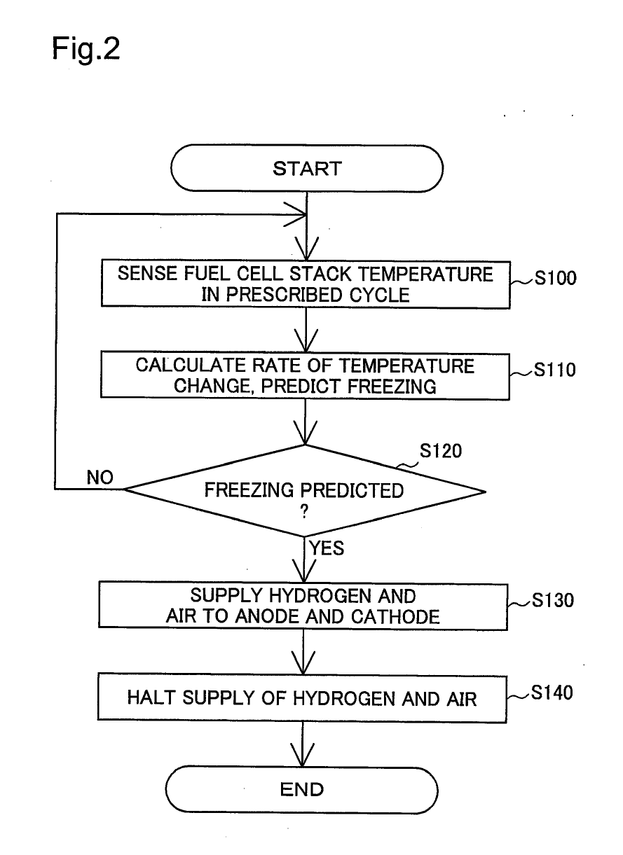

FIG. 2 is a flowchart showing the flow of the operation control process subsequent to discontinuing generation by the fuel cell stack 100 according to the first embodiment. This process is one that is executed by the CPU of the control unit 80.

First, using the temperature sensor 90, the CPU senses the temperature of the fuel cell stack 100 in a prescribed cycle (Step S100). In the present embodiment, the temperature of the fuel cell stack 100 is sensed in a one-hour cycle. The duration of the prescribed cycle may be selected freely however. Additionally, the system may be designed such that the cycle of sensing the temperature of the fuel cell stack 100 varies according to the temperature sensed by the temperature sensor 90. For example, where the sensing cycle for temperature of the fuel cell stack 100 in the initial period subsequent to discontinuing generation is one hour, if the temperature of the fuel cell stack 100 subsequently falls below a prescribed temperature (e.g. 10° C.), the cycle for sensing temperature of the fuel cell stack 100 may be shortened to five minutes.

The CPU then computes the rate of change (rate of drop) of temperature of the fuel cell stack 100, and on the basis of the temperature of the fuel cell stack 100 and the rate of change of temperature of the fuel cell stack 100, predicts whether evolved water present in the membrane-electrode assembly inside the fuel cell stack 100 will freeze (Step S110). If the decision is that the evolved water in the membrane-electrode assembly will not freeze (Step S120: NO), the process returns to Step S100. Once a considerable period of time elapses subsequent to discontinuing generation by the fuel cell stack 100, the membrane-electrode assembly and the separators making up the fuel cell stack 100 reach substantially identical temperature.

If on the other hand the decision is that the evolved water in the membrane-electrode assembly will freeze (Step S120: YES), at timing just prior to the time that the membrane-electrode assembly is predicted to go below the freezing point, the CPU opens the shutoff valve 51, the regulator 52, and the exhaust valve 57, starts up the compressor 60, and supplies hydrogen and air respectively to the anode and cathode of the membrane-electrode assembly (Step S130) so that for a prescribed time interval the fuel cell stack 100 generates electricity, albeit at a lower level than during steady generation, whereupon the heat emitted by the membrane-electrode assembly due to this generation of electricity gives rise to a temperature gradient between the membrane-electrode assembly and the separators. This process corresponds to the temperature gradient formation control taught in the present invention. The prescribed time interval mentioned above may be selected arbitrarily within a range giving rise to the desired temperature gradient between the membrane-electrode assembly and the separators. The CPU then closes shutoff valve 51, the regulator 52, and the exhaust valve 57 and stops the compressor 60 to discontinue the feed of hydrogen and air to the anode and cathode of the membrane-electrode assembly (Step S140), and terminates the process.

### A3. Working Effects

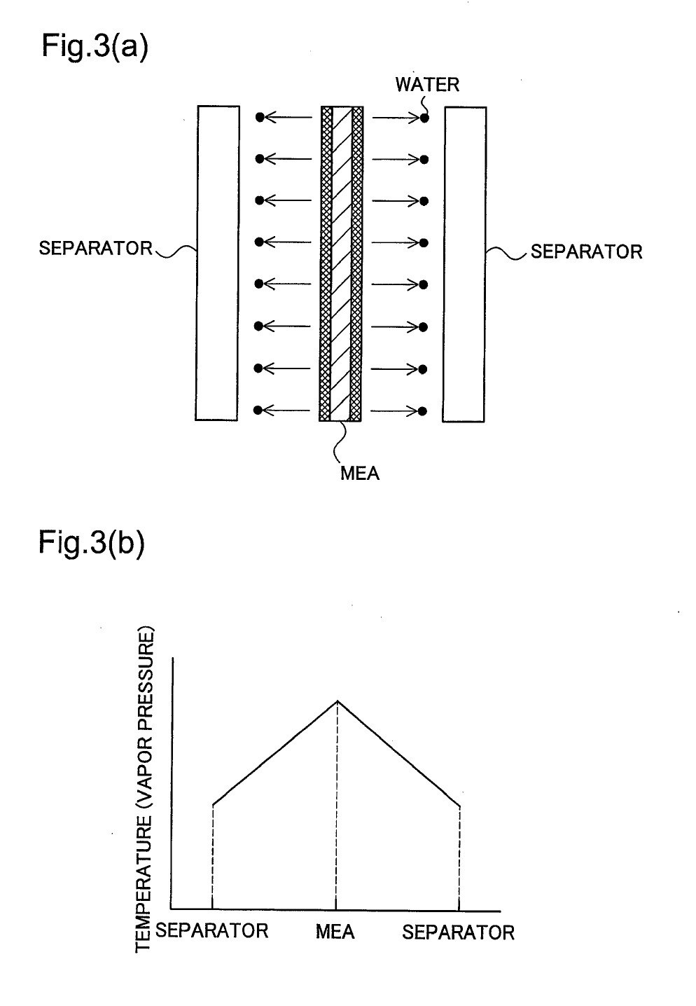

FIG. 3 is an illustration depicting the working effects of the operation control process subsequent to discontinuing generation as described above. In Step S130 of the operation control process described previously, by having the fuel cell stack 100 generate electricity for a prescribed time interval, a temperature gradient, that is, a vapor pressure gradient, is produced between the membrane-electrode assembly (MEA) and the separators, as depicted in FIG. 3 (b). As a result of this vapor pressure gradient, the evolved water present in the membrane-electrode assembly experiences driving force which transports it from the membrane-electrode assembly side, where the vapor pressure is higher, towards the separator side, where the vapor pressure is lower, whereupon the evolved water present in the membrane-electrode assembly moves from the membrane-electrode assembly side towards the separator side as depicted in FIG. 3 (a). The amount of evolved water present in the membrane-electrode assembly may be reduced thereby.

According to the fuel cell system 1000 of the preceding first embodiment, through operation control in the manner described above, evolved water present in the membrane-electrode assembly may be transported from the membrane-electrode assembly towards the separator side just prior to freezing of the evolved water, thereby preventing the evolved water present in the membrane-electrode assembly from freezing in a low-temperature environment below the freezing point, and improving low-temperature startup of the fuel cell system 1000. Moreover, during operation control as described above, generation by the fuel cell stack 100 (Step S130 of FIG. 2) is carried out only for period until the temperature gradient is formed between the membrane-electrode assembly and the separators, and is quickly discontinued thereafter. Thus, as compared with the prior art discussed earlier, namely, operating the fuel cell to expel evolved water remaining inside the fuel cell to the outside or operating the fuel cell to maintain the temperature above freezing, reduced energy efficiency of the fuel cell system 1000 may be avoided.

### B. SECOND EMBODIMENT

The features of the fuel cell system of the second embodiment are identical to the features of the fuel cell system of the first embodiment. However, the operation control process subsequent to discontinuing generation by the fuel cell stack 100 is different from that in the first embodiment. The operation control process that takes place in the fuel cell system of the second embodiment subsequent to discontinuing generation by the fuel cell stack 100 is described below.

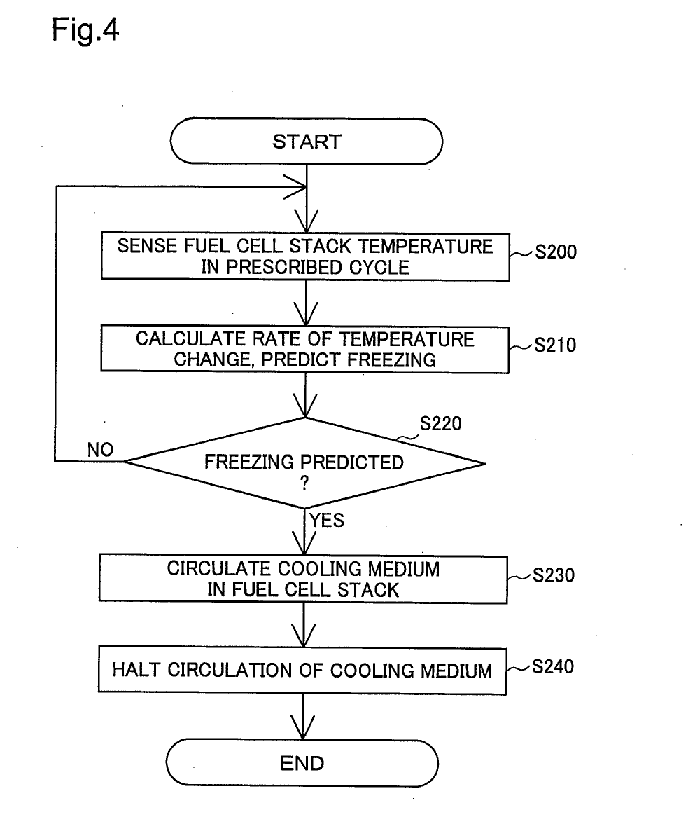

FIG. 4 is a flowchart showing the flow of the operation control process subsequent to discontinuing generation in the fuel cell stack 100 according the second embodiment. This process is one that is executed by the CPU of the control unit 80.

First, using the temperature sensor 90, the CPU senses the temperature of the fuel cell stack 100 in a prescribed cycle (Step S200). This is similar to Step S100 of the operation control process of the first embodiment.

The CPU then computes the rate of change (rate of drop) of temperature of the fuel cell stack 100, and on the basis of the temperature of the fuel cell stack 100 and the rate of change of temperature of the fuel cell stack 100, predicts whether evolved water present in the membrane-electrode assembly inside the fuel cell stack 100 will freeze (Step S210). If the decision is that the evolved water in the membrane-electrode assembly will not freeze (Step S220: NO), the process returns to Step S200.

If on the other hand the decision is that the evolved water in the membrane-electrode assembly will freeze (Step S220: YES), at timing just prior to the time that the membrane-electrode assembly is predicted to go below the freezing point, the CPU starts up the pump 70 for circulating the cooling medium and the radiator 71, and circulates the cooling medium through the fuel cell stack 100 (Step S230) to cool the separators for a prescribed time interval and produce a temperature gradient between the membrane-electrode assembly and the separators. As described previously, because the fuel cell stack 100 is housed within a heat insulating case while cooling equipment such as the pump 70 and the radiator 71 is situated outside the case, the temperature of the cooling medium is lower than the temperature of the separators. Thus, the temperature of the separators can be lowered by circulating the cooling medium through the fuel cell stack 100. The CPU then stops the pump 70 and the radiator 71, discontinues circulation of the cooling medium (Step S240), and terminates the process.

Like the fuel cell system 1000 according to the first embodiment, in the fuel cell system 1000 according to the second embodiment discussed above, by creating a temperature gradient between the membrane-electrode assembly and the separators just prior to freezing of the evolved water and transporting this evolved water from the membrane-electrode assembly towards the separator side, freezing of evolved water in the membrane-electrode assembly in a low-temperature environment below the freezing point may be avoided, and low-temperature startup of the fuel cell system 1000 may be improved. In operation control as described above, circulation of coolant (Step S230 of FIG. 4) is carried out only for period until the temperature gradient is formed between the membrane-electrode assembly and the separators, and is quickly discontinued thereafter. Thus, like the first embodiment, as compared with the prior art discussed earlier, namely, operating the fuel cell to expel evolved water remaining inside the fuel cell to the outside or operating the fuel cell to maintain the temperature above freezing, reduced energy efficiency of the fuel cell system 1000 may be avoided.

### C. THIRD EMBODIMENT

### C1. Features of Fuel Cell System:

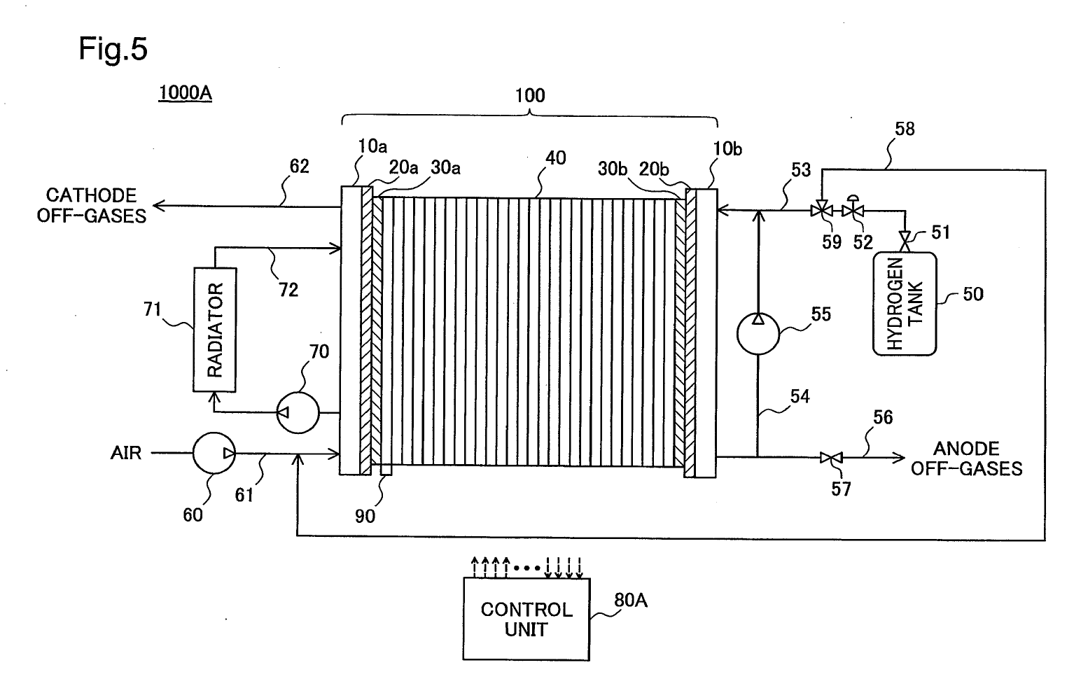

FIG. 5 is an illustration depicting the general features of a fuel cell system 1000A according to a third embodiment of the invention. The features of this fuel cell system 1000A are substantially identical to the features of a fuel cell system 1000 according to the first embodiment and the second embodiment. However, as illustrated, the fuel cell system 1000A according to the third embodiment has a line 58 for circulating hydrogen from the line 53 to the line 61, and a three-way valve 59 for switching between circulating hydrogen to the fuel cell stack 100 and circulating it to the line 58. By actuating the compressor 60 to circulate air to the line 61 while controlling the three-way valve 59 to circulate hydrogen to the line 61, a mixed gas of hydrogen and air may be circulated to the cathodes of the fuel cell stack 100. The fuel cell system 1000A is provided with a control unit 80A in place of the control unit 80.

### C2. Operation Control Process After Discontinuing Generation:

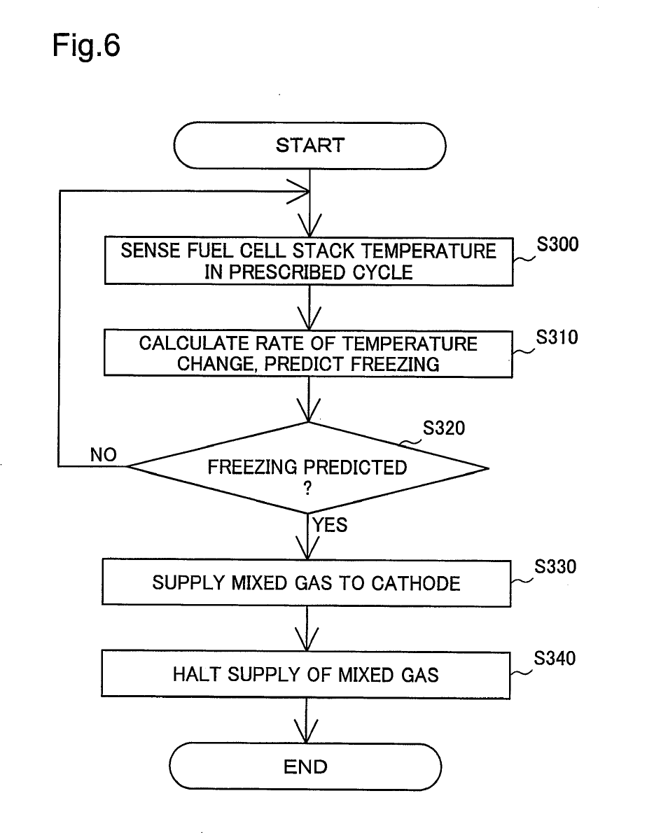

FIG. 6 is a flowchart showing the flow of the operation control process subsequent to discontinuing generation in the fuel cell stack 100 according the third embodiment. This process is one that is executed by the CPU of the control unit 80A.

First, using the temperature sensor 90, the CPU senses the temperature of the fuel cell stack 100 in a prescribed cycle (Step 300). This is similar to Step S100 of the operation control process of the first embodiment.

The CPU then computes the rate of change (rate of drop) of temperature of the fuel cell stack 100, and on the basis of the temperature of the fuel cell stack 100 and the rate of change of temperature of the fuel cell stack 100, predicts whether evolved water present in the membrane-electrode assembly inside the fuel cell stack 100 will freeze (Step S310). If the decision is that the evolved water in the membrane-electrode assembly will not freeze (Step S320: NO), the process returns to Step S300.

If on the other hand the decision is that the evolved water in the membrane-electrode assembly will freeze (Step S320: YES), at timing just prior to the time that the membrane-electrode assembly is predicted to go below the freezing point, the CPU opens the shutoff valve 51 and the regulator 52, controls the three-way valve 59 to circulate hydrogen from the line 53 to the line 58, and starts up the compressor 60 to supply the mixed gas of hydrogen and air to the cathode of the membrane-electrode assembly for a prescribed time interval (Step S330). Thereupon, the hydrogen and the oxygen contained in the air combust on the catalyst contained in the catalyst layer of the cathode of the membrane-electrode assembly, and the heat emitted from the membrane-electrode assembly (catalyst layer) as a result of this combustion gives rise to a temperature gradient between the membrane-electrode assembly and the separators. This process corresponds to the temperature gradient formation control taught in the present invention. The CPU then closes shutoff valve 51 and the regulator 52, returns the three-way valve 59 to its original position, stops the compressor 60 to discontinue the feed of mixed gas to the cathode of the membrane-electrode assembly (Step S340), and terminates the process.

Like the fuel cell system 1000 according to the first embodiment, in the fuel cell system 1000A according to the third embodiment discussed above, by creating a temperature gradient between the membrane-electrode assembly and the separators just prior to freezing of the evolved water, and transporting the evolved water from the membrane-electrode assembly towards the separator side, freezing of evolved water in the membrane-electrode assembly in a low-temperature environment below the freezing point may be avoided, and low-temperature startup of the fuel cell system 1000 may be improved. In operation control as described above, supply of the mixed gas to the cathode of the membrane-electrode assembly (Step S330 of FIG. 6) is carried out only for period until the temperature gradient is formed between the membrane-electrode assembly and the separators, and is quickly discontinued thereafter. Thus, like the first embodiment, as compared with the prior art discussed earlier, namely, operating the fuel cell to expel evolved water remaining inside the fuel cell to the outside or operating the fuel cell to maintain the temperature above freezing, reduced energy efficiency of the fuel cell system 1000A may be avoided.

### D. MODIFIED EXAMPLES

While the invention is shown herein in terms of certain preferred embodiments, it is to be understood that there is no intention to limit the invention to the embodiments herein, and that various different modes are possible within the spirit and scope of the invention. Modifications such as the following are possible for example.

### D1. Modified Example 1

Certain features of the first to third embodiments described above may be combined. For example, by combining the operation control process subsequent to discontinuing generation in the fuel cell stack 100 according the first embodiment with the operation control process subsequent to discontinuing generation in the fuel cell stack 100 according the second embodiment, when it is predicted that evolved water in the membrane-electrode assembly of the fuel cell stack 100 will freeze, electricity may be generated while at the same time circulating the cooling medium. Alternatively, by combining the operation control process subsequent to discontinuing generation in the fuel cell stack 100 in the fuel cell system 1000A according to the third embodiment with the operation control process subsequent to discontinuing generation by the fuel cell stack 100 according the second embodiment, when it is predicted that evolved water in the membrane-electrode assembly of the fuel cell stack 100 will freeze, the mixed gas may be combusted on the catalyst contained in the catalyst layer of the membrane-electrode assembly while at the same time circulating the cooling medium.

### D2. Modified Example 2:

In the preceding third embodiment, the fuel cell system 1000A includes the line 58 and the three-way valve 59, and in the operation control process subsequent to discontinuing generation by the fuel cell stack 100, the mixed gas is supplied to the cathode of the membrane-electrode assembly, and combustion of hydrogen and oxygen is brought about on the catalyst contained in the catalyst layer of the cathode; however, this is not intended to limit the present invention. It is possible for the mixed gas to be supplied to at least one of the anode or cathode of the membrane-electrode assembly, and combustion of hydrogen and oxygen brought about on the catalyst contained in the catalyst layer.

### D3. Modified Example 3

In the preceding embodiments, in the operation control process subsequent to discontinuing generation by the fuel cell stack 100, freezing of evolved water in the membrane-electrode assembly inside the fuel cell stack 100 is predicted on the basis of the temperature of the fuel cell stack 100 and the rate of change of temperature of the fuel cell stack 100; however, this is not intended to limit the present invention. It is possible to instead sense or calculate the temperature of the outside environment of the fuel cell stack 100, the rate of change in temperature of the outside environment, the temperature of the cooling medium, or the rate of change in temperature of the cooling medium, and to then predict freezing of evolved water in the membrane-electrode assembly inside the fuel cell stack 100 on the basis of at least one of these parameters.

1. A fuel cell system comprising:
a fuel cell in which a membrane-electrode assembly and separators are stacked, the membrane-electrode assembly and separators are stacked, the membrane-electrode assembly having an anode and a cathode respectively joined to either side of an electrolyte membrane and being sandwiched by separators;
a fuel gas supply portion which supplies a fuel gas to the anode;
an oxidant gas supply portion which supplies an oxidant gas to the cathode;
a cooling medium circulating portion which circulates a cooling medium for cooling the fuel cell through a cooling medium channel formed in the separator; and
a controller, wherein
subsequent to discontinuing generation by the fuel cell, the controller,
if predicted that evolved water formed by electrochemical reaction of the fuel gas and the oxidant gas during generation may freeze in the membrane-electrode assembly, starts up at least one of the fuel gas supply portion, the oxidant gas supply portion, and the cooling medium circulating portion to carry out temperature gradient formation control which creates a temperature gradient in the fuel cell such that a temperature at the membrane-electrode assembly side is relatively higher than a temperature at the side of the separator with the cooling medium channel; and after the temperature gradient control is carried out only for a prescribed period for creating the temperature gradient, terminates the temperature gradient formation control and maintains the system in a state of discontinued generation.

2. The fuel cell system in accordance with claim 1 wherein
the controller accomplishes the temperature gradient formation control by starting up the fuel gas supply portion and the oxidant gas supply portion and generating electricity with the fuel cell until the temperature of the membrane-electrode assembly side is relatively higher than the temperature at the separator side in the fuel cell.

3. The fuel cell system in accordance with claim 1 wherein
the controller accomplishes the temperature gradient formation control by starting up the cooling medium circulating portion and circulating the cooling medium through the separator until the temperature at the separator side is relatively lower than the temperature at the membrane-electrode assembly side in the fuel cell.

4. The fuel cell system in accordance with claim 1 wherein
the anode and the cathode contain a catalyst which facilitates reaction of the fuel gas and the oxidant gas,
the fuel cell system further includes a mixed gas supply portion which supplies a mixed gas of the fuel gas and the oxidant gas to at least one of the anode and the cathode, and
the controller accomplishes the temperature gradient formation control by starting up the mixed gas supply portion and combusting the mixed gas on the catalyst until the temperature at the membrane-electrode assembly side is relatively higher than the temperature of the separator side in the fuel cell.

5. A method of controlling a fuel cell system, wherein
the fuel cell system includes:
a fuel cell including a membrane-electrode assembly and separators are stacked, the membrane-electrode assembly having an anode and a cathode respectively joined to either side of an electrolyte membrane and being sandwiched by separators;
a fuel gas supply portion which supplies a fuel gas to the anode;
an oxidant gas supply portion which supplies an oxidant gas to the cathode; and
a cooling medium circulating portion which circulates a cooling medium for cooling the fuel cell through a cooling medium channel formed in at least one of the separators;
the method comprising:
a freezing prediction step of predicting subsequent to discontinuing generation by the fuel cell as to whether evolved water formed by electrochemical reaction of the fuel gas and the oxidant gas during generation may freeze in the membrane-electrode assembly;
a temperature gradient formation step in which, if predicted in the freezing prediction step that the evolved water may freeze in the membrane-electrode assembly, at least one of the fuel gas supply portion, the oxidant gas supply portion, and the cooling medium circulating portion is started up, and a temperature gradient is created in the fuel cell such that a temperature at the membrane-electrode assembly side is relatively higher than a temperature at a side of the separator with the cooling medium channel; and
a step of terminating the temperature gradient formation step once after the temperature gradient formation step is carried out only for a prescribed period for creating the temperature gradient, and maintaining the system in a state of discontinued generation.
